(19) United States
(12) Patent Application Publication
(10) Pub. No.: US 2014/0295400 A1
(43) Pub. Date: Oct. 2, 2014

(54) Systems and Methods for Assessing Conversation Aptitude

(71) Applicant: Educational Testing Service, Princeton, NJ (US)

(72) Inventors: Diego Zapata-Rivera, Pennington, NJ (US); Youngsoon So, Princeton, NJ (US); Lei Liu, Ewing, NJ (US)

(73) Assignee: Educational Testing Service, Princeton, NJ (US)

(21) Appl. No.: 14/227,436

(22) Filed: Mar. 27, 2014

Related U.S. Application Data
(60) Provisional application No. 61/805,670, filed on Mar. 27, 2013.
(60) Provisional application No. 61/808,858, filed on Apr. 5, 2013.

(51) Int. Cl. G09B 7/00; G09B 19/00

(52) U.S. Cl. CPC G09B 7/00; G09B 19/00
USPC 434/362

(57) ABSTRACT

Systems and methods are described for providing an assessment of a conversational aptitude of a test taker. A system includes a computer-readable medium configured for storage of a conversational aptitude assessment data structure. A conversational aptitude assessment data structure includes conversation cycle data records describing a plurality of conversation cycles between a virtual personality and the test taker, where a conversation cycle data record includes a virtual personality script and a plurality of model test taker responses and associated cycle links, where each cycle link identifies a next conversation cycle data record. A data processor is configured to access a first conversation cycle data record, determine the model test taker response with which a test taker response is most similar, and select a next conversation cycle data record identified with the cycle link associated with the most similar model test taker response.

### CROSS-REFERENCE TO RELATED APPLICATIONS

The present application claims priority from U.S. Provisional Application Ser. No. 61/805,670 entitled “Trialogue Capability,” filed 27 Mar. 2013, and U.S. Provisional Application Ser. No. 61/808,858 entitled “Using Trialogues to Assess Science Inquiry Skills in a Game-Like Assessment,” filed Apr. 5, 2013, the entirety of each of which is hereby incorporated by reference.

### FIELD

This disclosure is related generally to language skill assessment and more particularly to assessment of test taker conversational ability.

### BACKGROUND

Computer games and simulations have been used to support learning, including language skills and subject matter skills, such as science concepts and science process skills. Such environments can offer students an engaging learning experience that leads to greater student motivation. While such implementations can result in high levels of engagement, traditional embedded questions in such games and simulations fail in capturing all information that could be useful in assessing test taker skills.

### SUMMARY

Systems and methods are described for providing an assessment of a conversational aptitude of a test taker. A system includes a computer-readable medium configured for storage of a conversational aptitude assessment data structure. A conversational aptitude assessment data structure includes conversation cycle data records describing a plurality of conversation cycles between a virtual personality and the test taker, where a conversation cycle data record includes a virtual personality script and a plurality of model test taker responses and associated cycle links, where each cycle link identifies a next conversation cycle data record. Path score records identify a conversational aptitude score associated with a path of conversation cycle data records. One or more data processors are configured to access a first conversation cycle data record, provide the virtual personality script associated with the first conversation cycle data record, determine the model test taker response with which a test taker response is most similar, select a next conversation cycle data record identified with the cycle link associated with the most similar model test taker response, and determine a path score based on a path score record and a path of conversation cycle data records associated with the test taker.

As another example, a computer-implemented method of providing an assessment of a conversational aptitude of a test taker accesses a conversational aptitude data structure that contains conversation cycle data records describing a plurality of conversation cycles between a virtual personality and the test taker. A conversation cycle data record for a particular conversation cycle includes a virtual personality script and a plurality of model test taker responses and associated cycle links, where each cycle link identifies a next conversation cycle data record. The conversational aptitude data structure further includes path score records, where a path score record identifies a conversational aptitude score associated with a path of conversation cycle data records. The method further includes accessing a first conversation cycle data record, providing the virtual personality script associated with the first conversation cycle data record, determining the model test taker response with which a test taker response is most similar, selecting a next conversation cycle data record identified with the cycle link associated with the most similar model test taker response, and determining a path score based on a path score record and a path of conversation cycle data records associated with the test taker.

As a further example, a computer-readable medium is encoded with instructions for commanding one or more data processors to perform a method of providing an assessment of a conversational aptitude of a test taker. The method includes accessing a conversational aptitude data structure that contains conversation cycle data records describing a plurality of conversation cycles between a virtual personality and the test taker. A conversation cycle data record for a particular conversation cycle includes a virtual personality script and a plurality of model test taker responses and associated cycle links, where each cycle link identifies a next conversation cycle data record. The conversational aptitude data structure further includes path score records, where a path score record identifies a conversational aptitude score associated with a path of conversation cycle data records. The method further includes accessing a first conversation cycle data record, providing the virtual personality script associated with the first conversation cycle data record, determining the model test taker response with which a test taker response is most similar, selecting a next conversation cycle data record identified with the cycle link associated with the most similar model test taker response, and determining a path score based on a path score record and a path of conversation cycle data records associated with the test taker.

### BRIEF DESCRIPTION OF THE DRAWINGS

FIG. 1 is a block diagram depicting a computer-implemented system for providing an assessment of a conversational aptitude of a test taker.

FIGS. 2A and 2B depict an example of a virtual personality script being provided to a test taker.

FIG. 3 depicts a second digital avatar responding to the test taker's submission of a correct response.

FIG. 4 is a block diagram depicting an example system for providing an assessment of conversational aptitude that utilizes a conversational aptitude assessment data structure.

FIGS. 5 and 6 depict example conversation cycle paths and scoring thereof

FIG. 7 is a diagram depicting an example conversation cycle data record format.

FIG. 8 is a diagram depicting path score records associated with different conversation paths.

FIG. 9 is a block diagram depicting a system for providing an assessment of a conversational aptitude of a test taker.

FIG. 10 depicts an example test interface where the virtual personality script is provided in text form without display of the digital avatar.

FIG. 11 is a flow diagram depicting a computer-implemented method of providing an assessment of a conversational aptitude of a test taker.

FIGS. 12A, 12B, and 12C depict example systems for use in implementing a conversation aptitude analysis engine.

### DETAILED DESCRIPTION

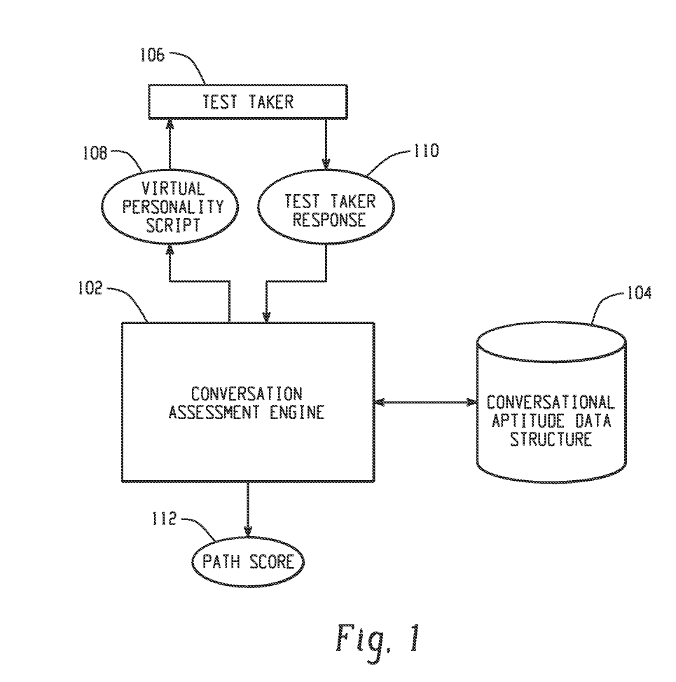

FIG. 1 is a block diagram depicting a computer-implemented system for providing an assessment of a conversational aptitude of a test taker. The system includes a conversation assessment engine 102 that is responsive to one or more computer-readable data stores 104 that contain data for providing a conversational aptitude assessment. The conversation assessment engine 102 engages a test taker 106 in a virtual conversation, where the test taker 106 is provided virtual personality script 108 via text or audio that is associated with a virtual personality. The conversation assessment engine 102 receives a test taker response 110, where such a test taker response 110 is provided vocally and processed via automatic speech recognition (ASR), via typing on a keyboard or touch screen, or via other data entry mechanism. The test taker response 110 is analyzed by the conversation assessment engine 102 to determine a next virtual personality script 108 to provide to the test taker 106 to continue the conversation in a next conversation cycle (e.g., a next virtual personality script 108 and corresponding test taker response 110). Based on a series of conversation cycles, the conversation assessment engine 102 is configured to provide one or more scores 112 that indicate a quality exhibited by the test taker 106 in one or more areas that the conversation assessment engine 102 is configured to analyze.

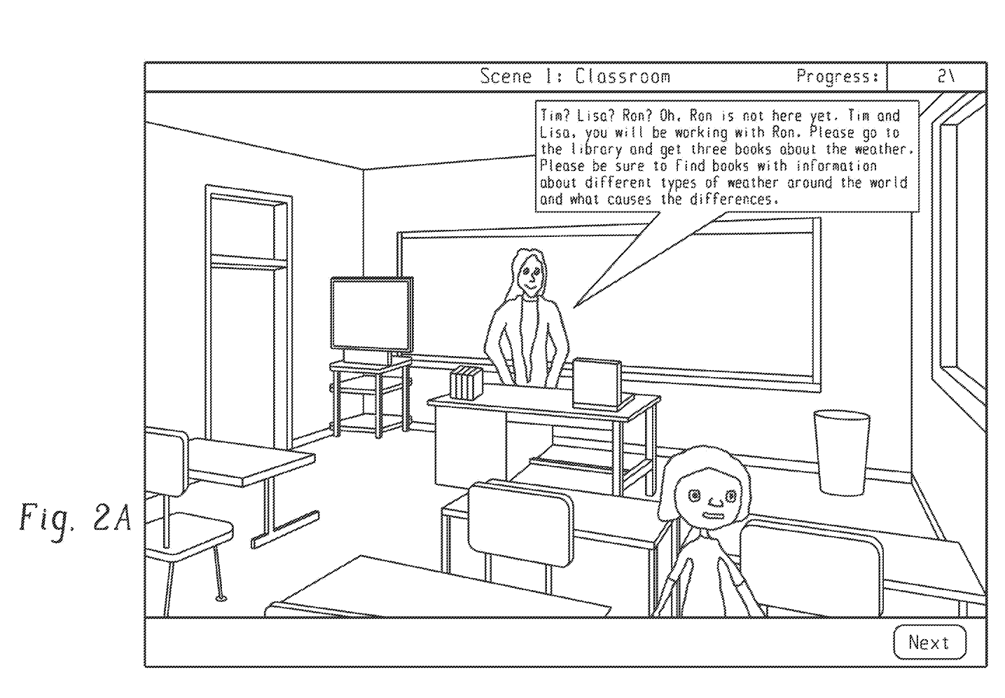

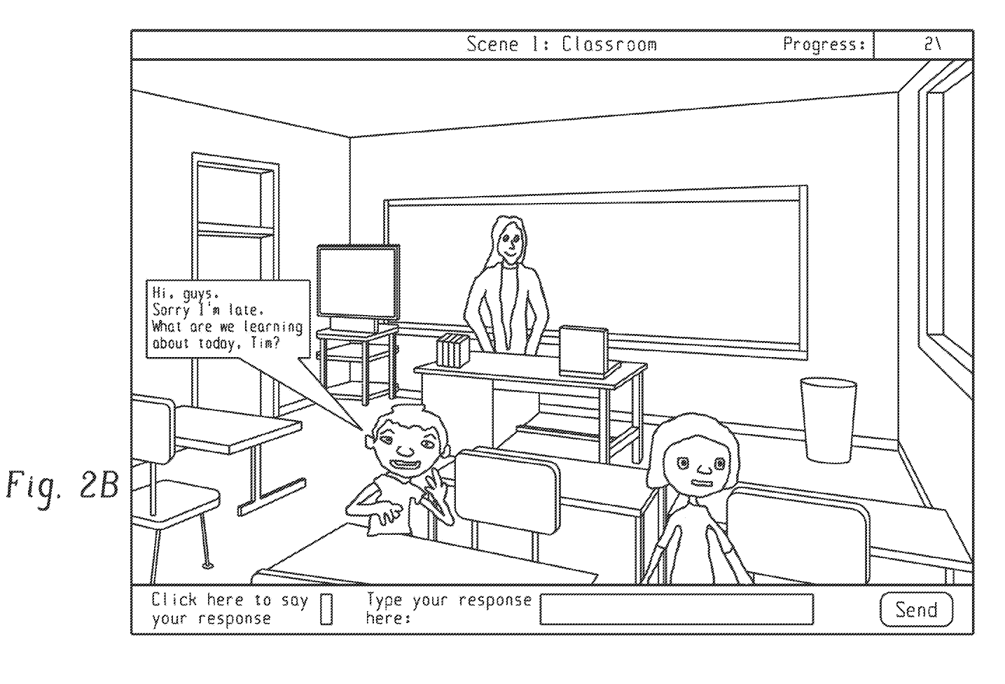

FIGS. 2A and 2B depict an example of a virtual personality script being provided to a test taker. In FIG. 2A, two digital avatars having substantially human appearances are displayed. A first digital avatar depicts a teacher, while a second digital avatar depicts a student, Lisa. The first avatar is depicted speaking in FIG. 2A, where the speech of the first avatar, accessed from a virtual personality script, is displayed via a speech bubble. In one example, the text of the speech bubble is also provided to a test taker aurally via a speaker. In a further example, the virtual personality script is provided in an audio-only fashion, without the text display in the speech bubble. In the example of FIG. 2A, the teacher digital avatar provides text describing an assignment where students are to go to the library to get three books describing weather around the world. The teacher avatar's speech is directed to the test taker, Tim, the second digital avatar Lisa, and a third digital avatar Ron, who is not yet arrived in the scene.

In FIG. 2B, the third digital avatar Ron has arrived in the scene and virtual personality script text is provided to the text taker via a speech bubble associated with Ron. Ron's virtual personality script text asks a question that asks what the students are learning today. The answer to that question was previously provided via the earlier portion of virtual personality script associated with the teacher displayed in FIG. 2A. Thus, the second portion of the virtual personality script asks a question that seeks an answer provided in the earlier, first portion of the virtual personality script. Such a conversation structure provides an opportunity to assess the test taker's comprehension abilities (e.g., reading, listening, subject matter), where the test taker's comprehension of the first portion of the virtual personality script is tested via the question in the second portion of the virtual personality script. At the bottom of FIG. 2B, the test taker is provided two mechanisms for entering a response to digital avatar Ron's question. The test taker can provide a response via a text entry box, or the test taker can click a control that activates a microphone for entry of a response vocally. Such a vocal response can be provided for automatic speech recognition to translate the vocal response into a text representation.

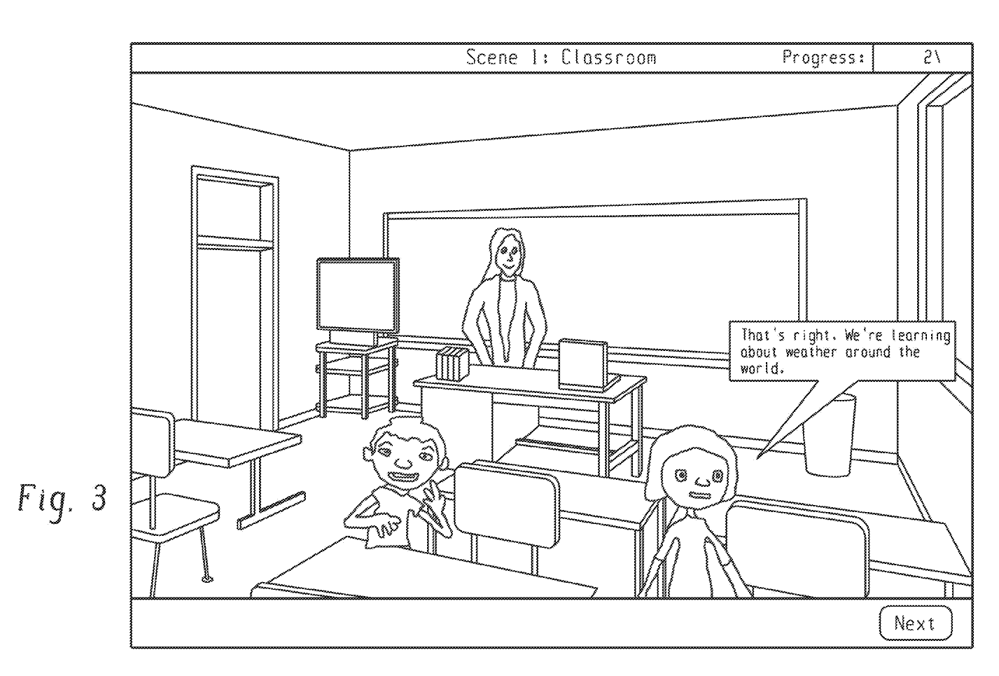

Upon receiving the test taker response, the conversation assessment engine analyzes the response to determine a most appropriate next virtual personality script to provide to the test taker to continue the conversation. FIG. 3 depicts the second digital avatar Lisa responding to the test taker's submission of a correct response that the students are learning about weather around the world.

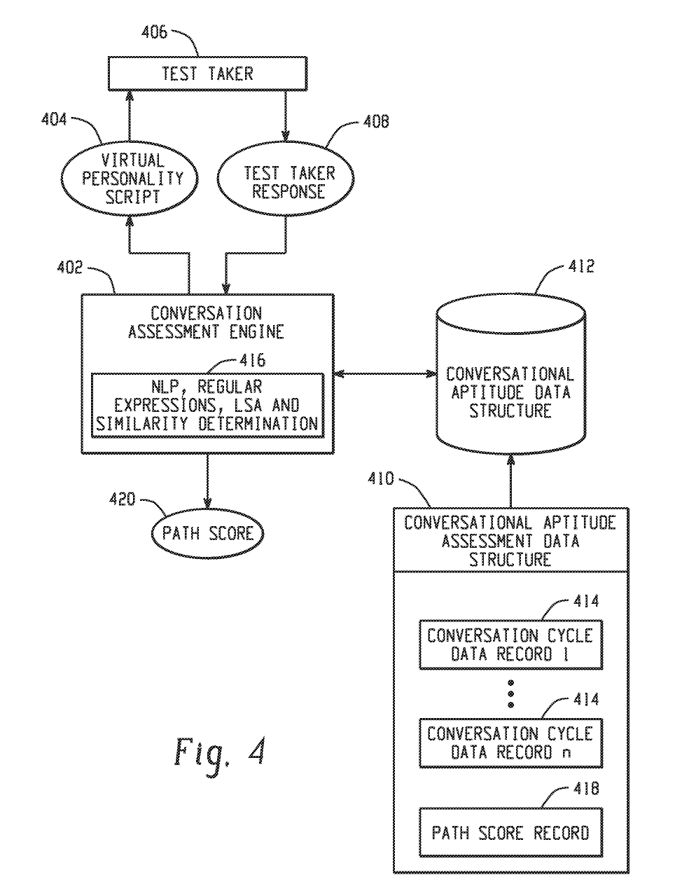

FIG. 4 is a block diagram depicting an example system for providing an assessment of conversational aptitude that utilizes a conversational aptitude assessment data structure. A conversation assessment engine 402 provides a virtual personality script 404 to a test taker 406 and receives a corresponding test taker response 408 to complete a conversation cycle. The conversation assessment engine 402 is then configured to determine a next virtual personality script 404 to provide to the test taker 406 to begin a next conversation cycle.

In the example of FIG. 4, the conversation assessment engine 402 utilizes a conversational aptitude assessment data structure 410 stored on a computer-readable medium 412 to determine the next virtual personality script 404 to be provided to the test taker 406. The conversational aptitude assessment data structure 410 includes a plurality of conversation cycle data records 414 (e.g., records 1-n). Each conversation cycle data record 414 corresponds to one conversation cycle (i.e., a virtual personality script 404 and corresponding test taker response 408). An example conversation cycle data record 414 includes a virtual personality script for the conversation cycle. The data record 414 further includes a plurality of model test taker responses and associated cycle links. The conversation assessment engine 402 compares the test taker response 408 in a conversation cycle with each of the model test taker responses of the current conversation cycle data record 414 to determine to which model test taker response of the conversation cycle data record 414 that the test taker response 408 is most similar. Because the test taker response 408 may be a free form response (i.e., not a multiple choice response), the conversation assessment engine 402 may use natural language processing, such as regular expressions or latent semantic analysis to perform the similarity determination, as indicated at 416. When the conversation assessment engine 402 determines a model test taker response of the conversation cycle data record that is most similar to the test taker response 408, the conversation assessment engine 402 uses the cycle link associated with that model test taker response to identify a next conversation cycle data record 414 to utilize in administering the next conversation cycle. The conversation assessment engine 402 then provides the virtual personality script 404 associated with that next conversation cycle data record 414 to begin the next conversation cycle.

The conversational aptitude assessment data structure 410 of FIG. 4 further includes a path score record 418 that identifies one or more conversational aptitude scores associated with a path of conversation cycle data records 414. Based on the series of conversation cycle data records 414 utilized by the conversation assessment engine 402 in administering a conversation assessment to the test taker 406, a path score record 418 identifies one or more scores for the test taker that indicate the quality of the test taker's performance (e.g., a score for general conversational aptitude, a score for subject matter comprehension). Such path scores 420 are outputted for display to the test taker 406, reporting to a testing party, for storage in a computer-readable medium, or for other use by downstream software modules.

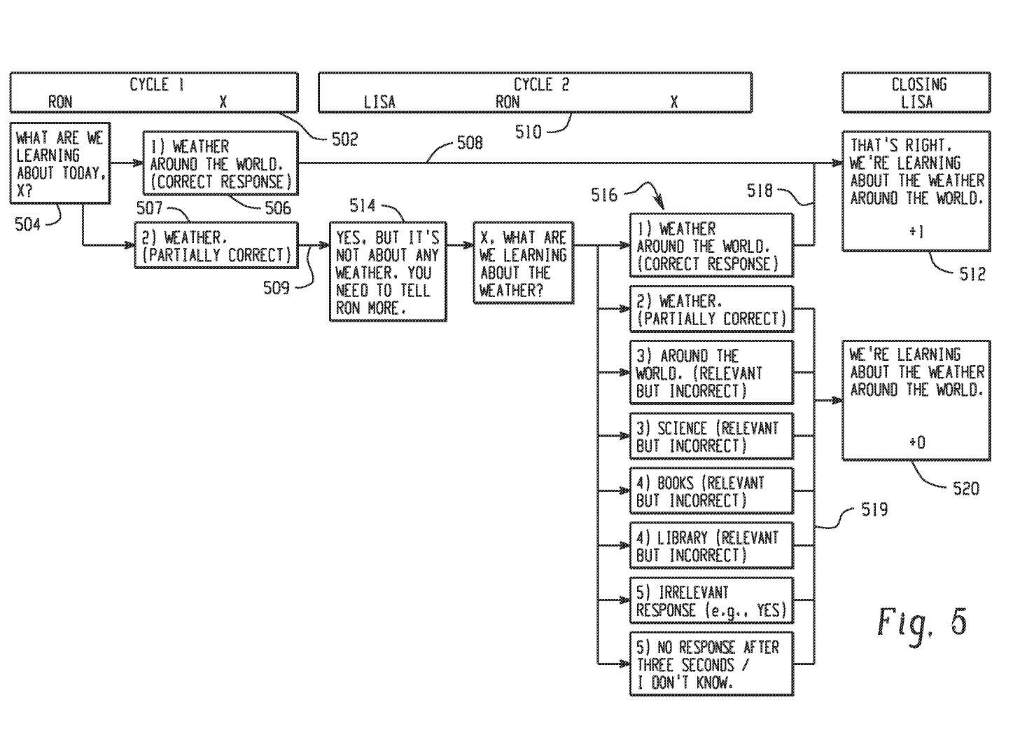

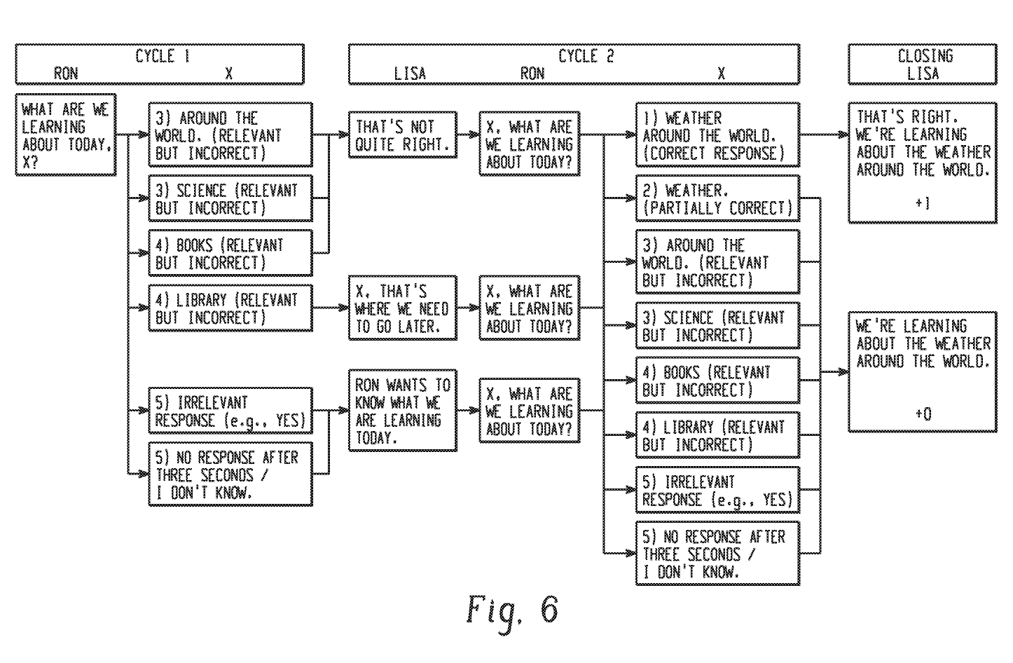

FIGS. 5 and 6 depict example conversation cycle paths and scoring thereof. FIG. 5 includes data associated with a first conversation cycle 502, such as could be stored in a first conversation cycle data record. The first conversation cycle 502 includes a virtual personality script 504 and a plurality of model test taker responses 506, 507. A conversation assessment engine provides the virtual personality script 504 to the test taker, incorporating the test taker's name in the position marked “X.” The conversation assessment engine determines to which of the model test taker responses 506, 507 the response received from the test taker is most similar. The conversation assessment engine utilizes a cycle link 508, 509 (e.g., a pointer, a database index value) associated with that most similar model test taker response to identify a next conversation cycle data record to access. In the example of FIG. 5, a first model test taker response 506 is a correct response. If the test taker gives the correct response on the first attempt, there is no need for additional conversation cycles to be executed. Thus, the cycle link 508 associate with that correct answer does 506 not point to a conversation cycle data record for the second conversation cycle 510. Instead, that cycle link 508 directs the conversation assessment engine to output text indicated by a path score record 512 indicating a correct answer and to award the test taker full credit, as indicated by the +1 score.

The second model test taker response 507 is associated with a partially correct response. The cycle link 509 associated with that model test taker response points to a conversation cycle data record 514 for a second conversation cycle 510. The virtual personality script for that conversation cycle data record 514 includes text to be displayed or aurally outputted for two different digital avatars. The conversation cycle data record further includes a number of model test taker responses 516 and destinations of cycle links 518, 519 associated with each of those model test taker responses 516. The conversation assessment engine determines to which of the model test taker responses 516 the test taker's second conversation cycle 510 test taker response is most similar. If the test taker response is most similar to the correct model test taker response, then cycle link 518 is selected, virtual personality script at path score record 512 indicating a correct response is provided, and the test taker is provided with full credit. If the test taker response is most similar to one of the other model test taker responses 516, then cycle link 519 is selected, virtual personality script at path score record 520 indicating an incorrect response is provided, and the test taker is provided with no credit. FIG. 6 depicts additional possible paths through the conversation that could be navigated by the conversation assessment engine, with resulting scores awarded based on traversals of those paths.

Conversations can be defined in a variety of formats utilizing conversation cycle data records. A conversation can be defined to utilize different numbers of conversation cycles, where the number of conversation cycles executed varies based on test taker responses. (Contrast path 504, 506, 508, 512 with path 504, 507, 509, 514, 516, 520 of FIG. 5.) In one example, a cycle link of a conversation cycle data record can include a pointer to its own conversation cycle data record for one or more of its model test taker responses (e.g., where a student responds, “What did you say?” a cycle link could point to its own conversation cycle data record to facilitate repeating of the associated virtual personality script). Such a repetition of one conversation cycle data record can be permitted for a limited number of times (e.g., 3 tries) before a cycle link associated with an incorrect response is traversed. In the example of FIGS. 5 and 6, a path score record 512, 520 at the end of the conversation indicates one whole number score for the test taker's performance in the conversation. In another example, fractional scores are implemented. In a further example, scores are provided for multiple characteristics of the test taker's performance (e.g., 0.7 points for conversation ability, 0.4 points for subject matter mastery). In a further example, path score records 512, 520 contain only scores and are not pointed to by cycle links. Instead, those path score records 512, 520 independently identify conversation cycle paths and scores associated therewith. To aid in conversation design, a system can be configured to access conversation cycle data records to generate a conversation display that includes a directed graph that indicates relationships among conversation cycle data records as indicated by cycle links.

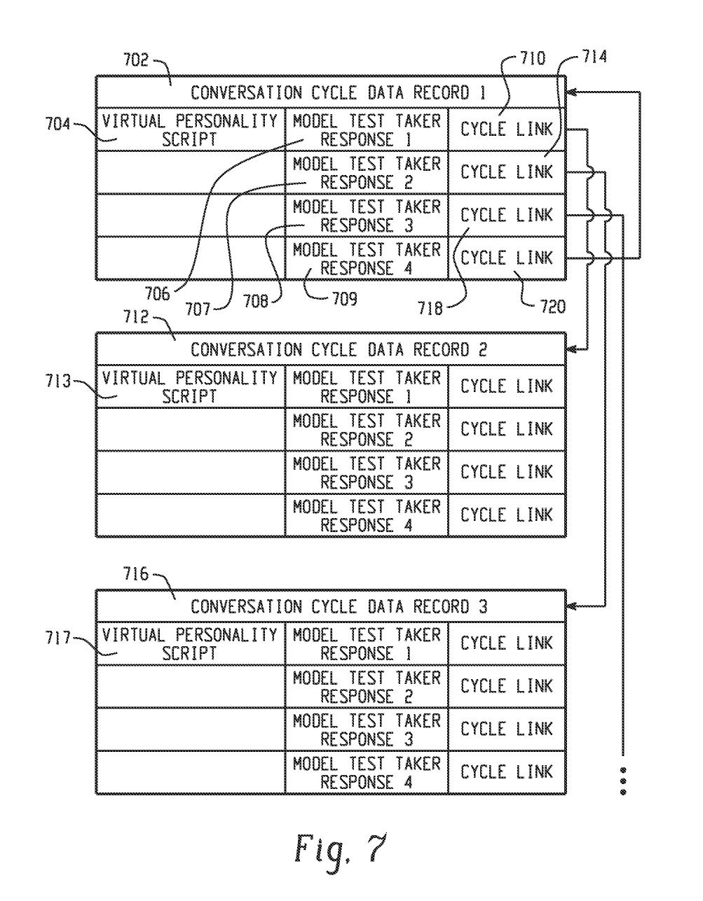

FIG. 7 is a diagram depicting an example conversation cycle data record format. A first conversation cycle data record 702 is selected for a first conversation cycle. Virtual personality script 704 associated with the first conversation cycle data record 702 is provided to a test taker. A first test taker response is received and compared to each of four model test taker responses 706, 707, 708, 709. When the test taker response is most similar to model response 1 706, a first cycle link 710 is used to access a second conversation cycle data record 712 for the next conversation cycle. The virtual personality script 713 for the second conversation cycle data record 712 is then provided to the test taker, and a test taker response is received.

When the test taker response is most similar to model response 2 707, a second cycle link 714 is used to access a third conversation cycle data record 716 for the next conversation cycle. The virtual personality script 717 for the third conversation cycle data record 716 is then provided to the test taker, and a test taker response is received. When the test taker response is most similar to model response 3 708, then cycle link 718 is accessed to identify a next conversation cycle data record to be utilized for the next conversation cycle.

When the test taker response is most similar to model response 4 709 (e.g., an indeterminate response such as “I don't know” or “What did you say?”), a fourth cycle link 720 is used to re-access the first conversation cycle data record 702 for the next conversation cycle. The virtual personality script 704 associated with the first conversation cycle data record 702 is provided to the test taker again, and a new test taker response is compared to the model test taker responses 706, 707, 708, 709 to identify a next cycle link 710, 714, 718, 720 to utilize. The self-identifying cycle link 720, in one example, may be accessed a limited number of times (e.g., 2 tries) before a cycle link associated with an incorrect answer is utilized instead.

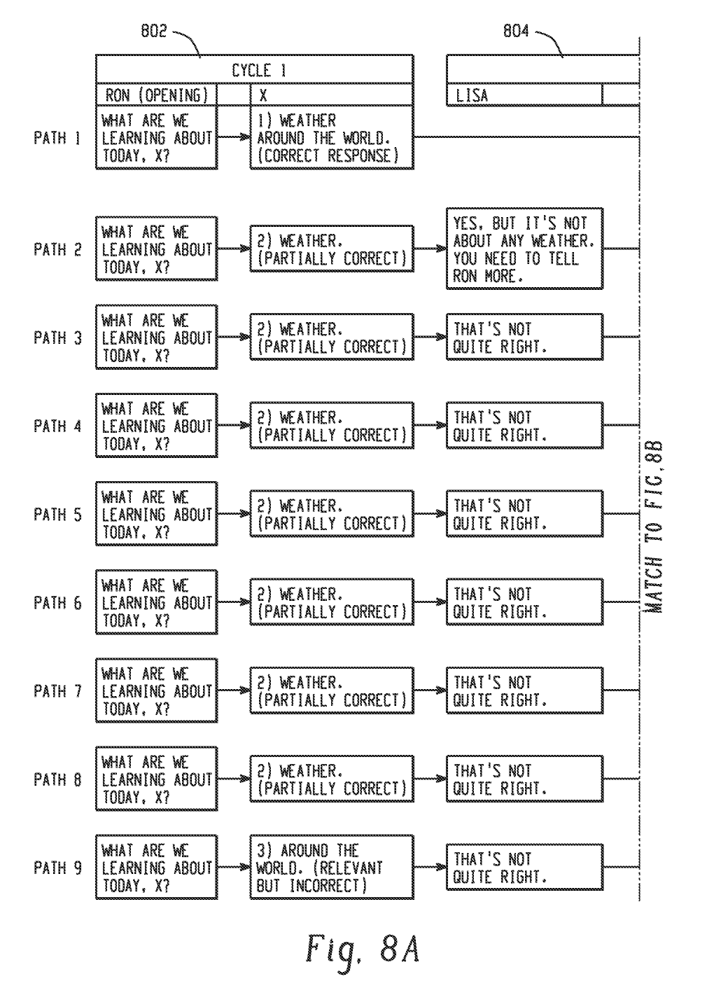

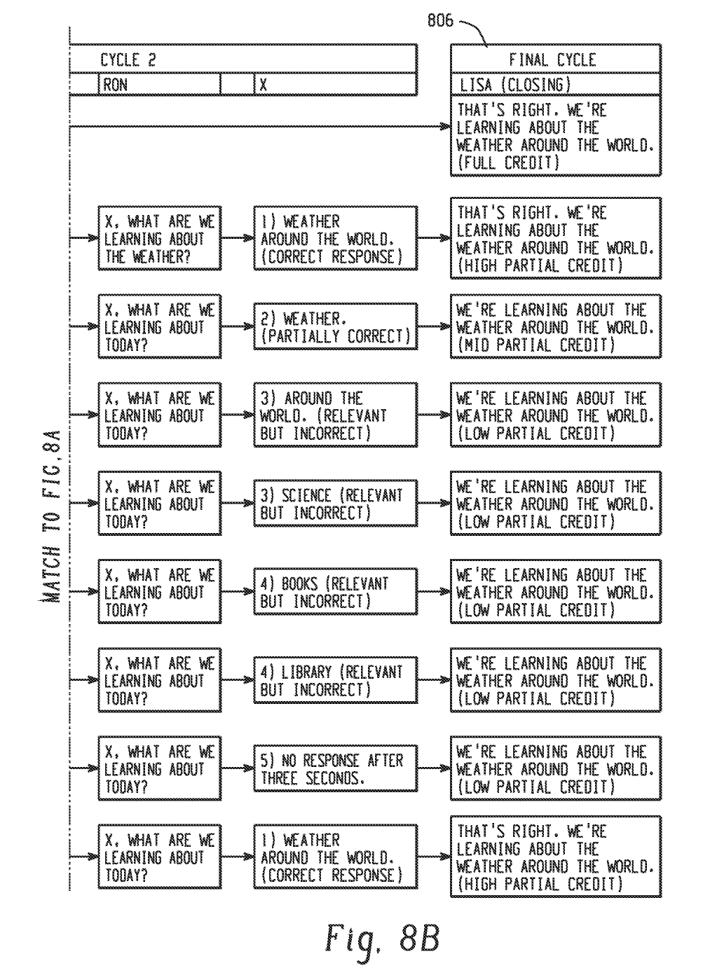

FIG. 8 is a diagram depicting path score records associated with different conversation paths. A first section 802 of FIG. 8 depicts a virtual personality script of a first conversation cycle data record and a plurality of different model test taker responses for that first conversation cycle data record. Based on which of the model test taker responses that the test taker response is most similar, a cycle path is selected that identifies a conversation cycle data record for the second cycle, depicted at 804. The second cycle section at 804 identifies a virtual personality script associated with the conversation cycle data record associated with the most similar model test taker response from cycle 1. The second cycle section further indicates model test taker responses associated with those second conversation cycle data records. Each of the second conversation cycle model test taker responses is associated with a cycle link to a path score record 806 that identifies a conversation aptitude score that is associated with the path of conversation cycle data records traversed by the test taker during the conversation. In another example, the path score record is not identified by the final cycle link, but is instead identified by a query of the cycle data records traversed during the conversation (e.g., a path score record indicates a score of 0.65 points where conversation cycle data records 1, 4, 7, and 10 are accessed in a conversation). The path score records of FIG. 8 offer full credit only for a correct answer in conversation cycle one, with partial credit being awarded for correct or partially correct answers received in the second conversation cycle.

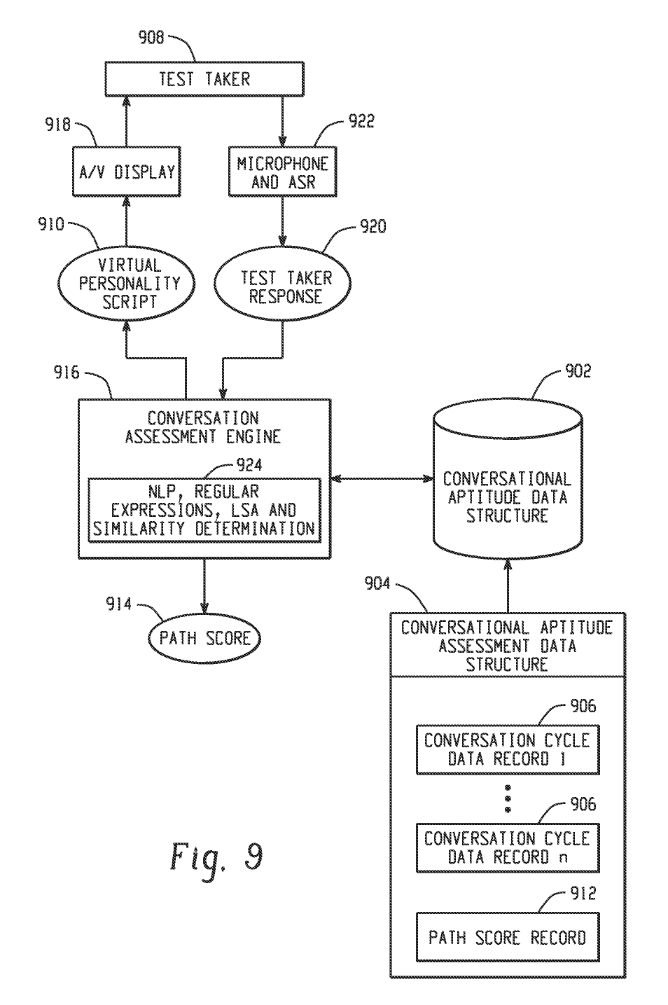

FIG. 9 is a block diagram depicting a system for providing an assessment of a conversational aptitude of a test taker. The system includes a computer-readable medium 902 configured for storage of a conversational aptitude assessment data structure 904. A conversational aptitude assessment data structure 904 includes conversation cycle data records 906 describing a plurality of conversation cycles between a virtual personality and the test taker 908, where a conversation cycle data record 906 includes a virtual personality script 910 and a plurality of model test taker responses and associated cycle links, where each cycle link identifies a next conversation cycle data record 906. Path score records 912 identify a conversational aptitude score 914 associated with a path of conversation cycle data records 906. One or more data processors of a conversation assessment engine 916 are configured to access a first conversation cycle data record 906, provide the virtual personality script 910 associated with the first conversation cycle data record 906 to the test taker 908 (e.g., via an audio or visual output 918), determine the model test taker response with which a test taker response 920 (e.g., received via a microphone and automated speech recognition processing 922) is most similar (e.g., via natural language processing and model test taker response comparison 924), select a next conversation cycle data record 906 identified with the cycle link associated with the most similar model test taker response, and determine a path score 914 based on a path score record 912 and a path of conversation cycle data records 906 associated with the test taker.

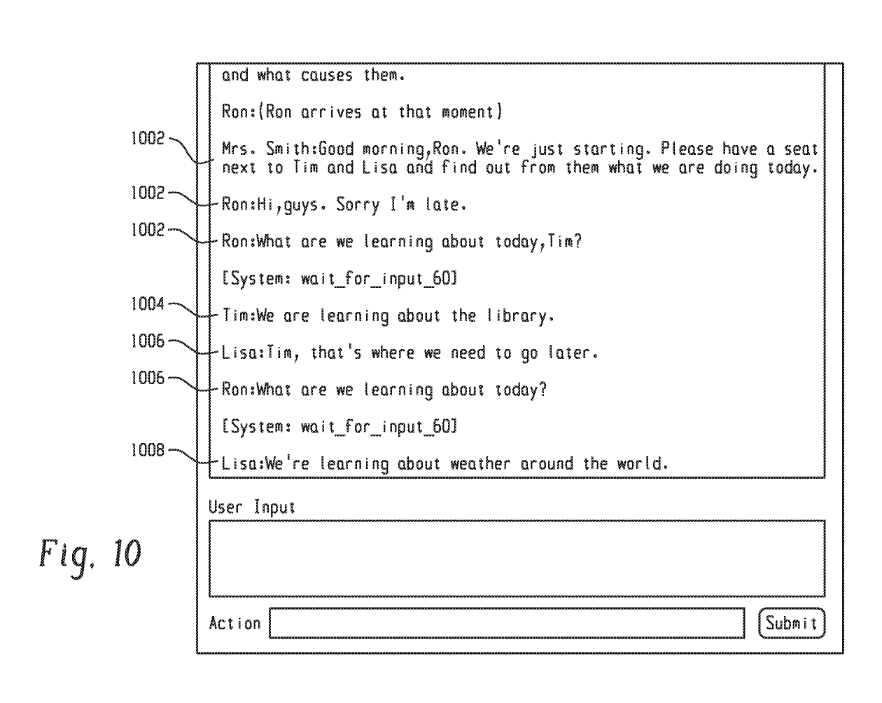

In addition to providing conversation map visual aids (e.g., directed graphs that indicate relationships among conversation cycle data records as indicated by cycle links), a conversation assessment engine can provide other assistance to conversation designers for testing purposes. For example, where a conversation assessment engine is configured to provide virtual personality scripts for plaintext display or for audio playback in association with video or picture display of a digital avatar, the conversation assessment engine can also provide a test interface to a conversation designer. FIG. 10 displays an example test interface where the virtual personality script 1002 is provided in text form without display of the digital avatar. Using the test interface, the tester provides a test-test taker response 1004 via the test interface. The conversation assessment engine accesses conversation cycle data records to identify the virtual personality script 1006 that would be outputted by the conversation assessment engine based on the test-test taker response 1004. The test interface is configured to then receive an additional test-test taker response. In the example of FIG. 10, the tester fails to enter a second test-test taker response, and the test interface provides a next virtual personality script 1008 associated with no response being entered (e.g., no response entered within 10 seconds).

FIG. 11 is a flow diagram depicting a computer-implemented method of providing an assessment of a conversational aptitude of a test taker. At 1102, a conversational aptitude data structure is accessed that contains conversation cycle data records describing a plurality of conversation cycles between a virtual personality and the test taker. A conversation cycle data record for a particular conversation cycle includes a virtual personality script and a plurality of model test taker responses and associated cycle links, where each cycle link identifies a next conversation cycle data record. The conversational aptitude data structure further includes path score records, where a path score record identifies a conversational aptitude score associated with a path of conversation cycle data records. The method further includes accessing a first conversation cycle data record at 1004, providing the virtual personality script associated with the first conversation cycle data record at 1106, determining the model test taker response with which a test taker response is most similar at 1108, selecting a next conversation cycle data record identified with the cycle link associated with the most similar model test taker response at 1110, and determining a path score based on a path score record and a path of conversation cycle data records associated with the test taker at 1112.

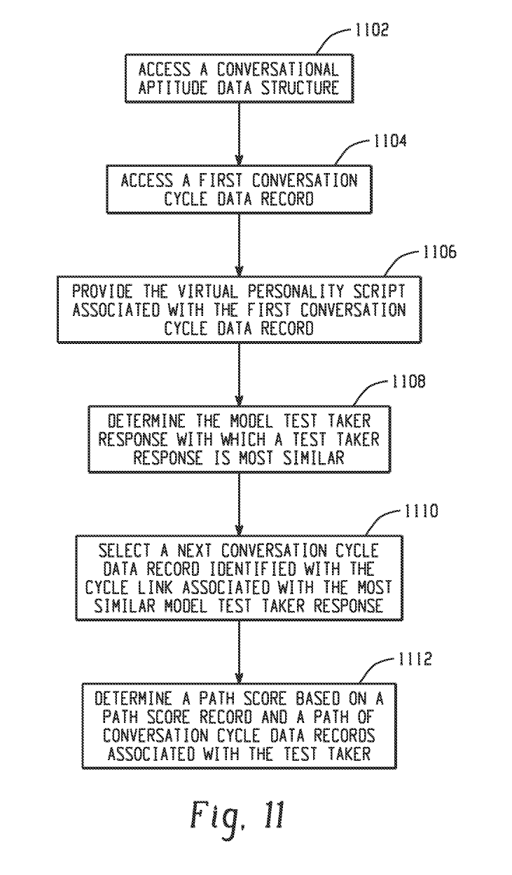

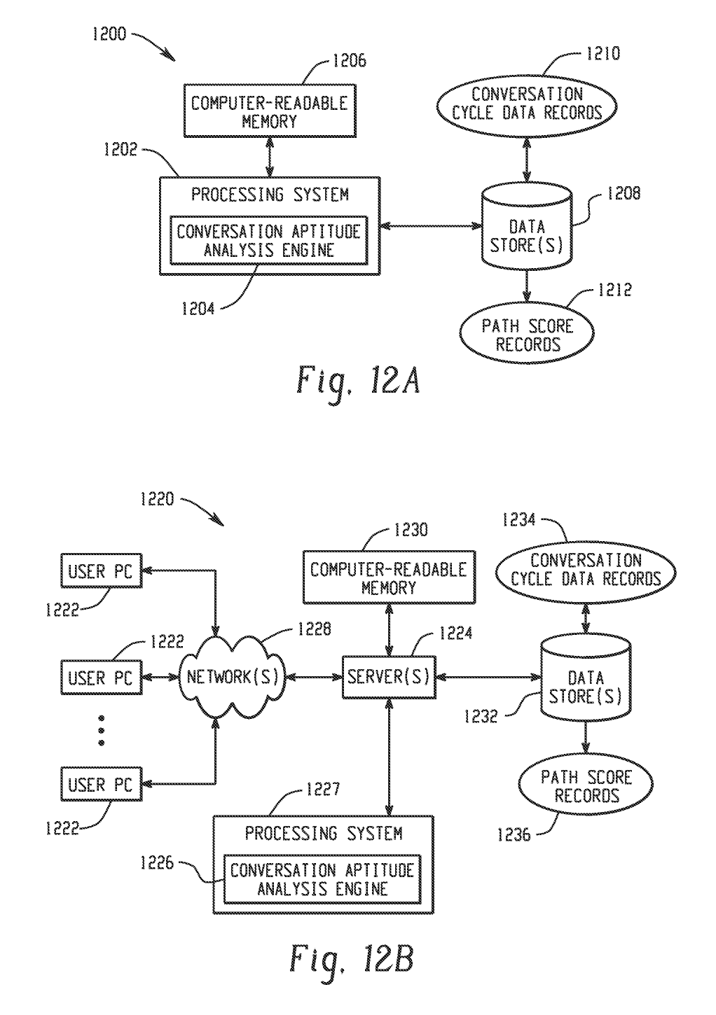

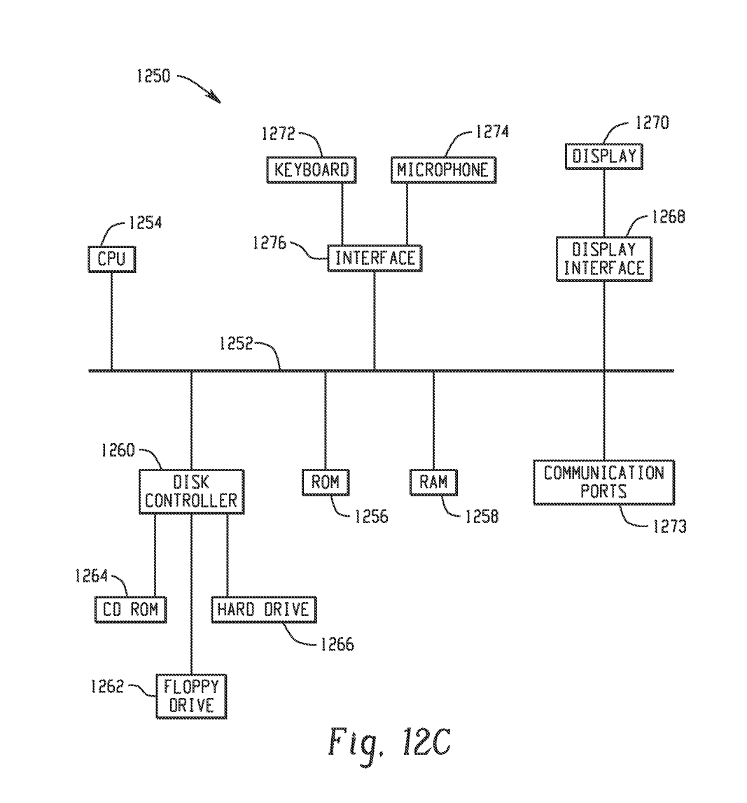

Examples have been used to describe the invention herein, and the scope of the invention may include other examples. FIGS. 12A, 12B, and 12C depict example systems for use in implementing a conversation aptitude analysis engine. For example, FIG. 12A depicts an exemplary system 1200 that includes a standalone computer architecture where a processing system 1202 (e.g., one or more computer processors located in a given computer or in multiple computers that may be separate and distinct from one another) includes a gaming detection engine 1204 being executed on it. The processing system 1202 has access to a computer-readable memory 1206 in addition to one or more data stores 1208. The one or more data stores 1208 may include conversation cycle data records 1210 as well as path score records 1212.

FIG. 12B depicts a system 1220 that includes a client server architecture. One or more user PCs 1222 access one or more servers 1224 running a conversation aptitude analysis 1226 on a processing system 1227 via one or more networks 1228. The one or more servers 1224 may access a computer readable memory 1230 as well as one or more data stores 1232. The one or more data stores 1232 may contain conversation cycle data records 1234 as well as path score records 1236.

FIG. 12C shows a block diagram of exemplary hardware for a standalone computer architecture 1250, such as the architecture depicted in FIG. 12A that may be used to contain and/or implement the program instructions of system embodiments of the present invention. A bus 1252 may serve as the information highway interconnecting the other illustrated components of the hardware. A processing system 1254 labeled CPU (central processing unit) (e.g., one or more computer processors at a given computer or at multiple computers), may perform calculations and logic operations required to execute a program. A non-transitory processor-readable storage medium, such as read only memory (ROM) 1256 and random access memory (RAM) 1258, may be in communication with the processing system 1254 and may contain one or more programming instructions for performing the method of implementing a conversation aptitude analysis engine. Optionally, program instructions may be stored on a non-transitory computer readable storage medium such as a magnetic disk, optical disk, recordable memory device, flash memory, or other physical storage medium.

A disk controller 1260 interfaces one or more optional disk drives to the system bus 1252. These disk drives may be external or internal floppy disk drives such as 1262, external or internal CD-ROM, CD-R, CD-RW or DVD drives such as 1264, or external or internal hard drives 1266. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1260, the ROM 1256 and/or the RAM 1258. Preferably, the processor 1254 may access each component as required.

A display interface 1268 may permit information from the bus 1252 to be displayed on a display 1270 in audio, graphic, or alphanumeric format. Communication with external devices may optionally occur using various communication ports 1273.

In addition to the standard computer-type components, the hardware may also include data input devices, such as a keyboard 1272, or other input device 1274, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, as used in the description herein and throughout the claims that follow, the meaning of “each” does not require “each and every” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented system for providing an assessment of a conversational aptitude of a test taker, comprising:
a computer-readable medium configured for storage of a conversational aptitude assessment data structure, wherein the conversational aptitude data structure contains data comprising:
conversation cycle data records describing a plurality of conversation cycles between a virtual personality and the test taker, wherein a conversation cycle data record for a particular conversation cycle comprises:
a virtual personality script; and
a plurality of model test taker responses and associated cycle links, wherein each cycle link identifies a next conversation cycle data record;
path score records, wherein a path score record identifies a conversational aptitude score associated with a path of conversation cycle data records;
one or more data processors configured to:
access a first conversation cycle data record;
provide the virtual personality script associated with the first conversation cycle data record;
determine the model test taker response with which a test taker response is most similar;
select a next conversation cycle data record identified with the cycle link associated with the most similar model test taker response; and
determine a path score based on a path score record and a path of conversation cycle data records associated with the test taker.

2. The system of claim 1, wherein the conversation cycle data record for the particular conversation cycle includes:
a virtual personality script that includes a question; and
a plurality of model test taker responses that include likely responses to the question.

3. The system of claim 1, wherein the one or more data processors are configured to determine the most similar model test taker response using one or more of: natural language processing, regular expressions, and latent semantic analysis.

4. The system of claim 1, wherein the one or more data processors are configured to provide the virtual personality script for plaintext display or for audio playback in association with video or picture display of a digital avatar of substantially human appearance.

5. The system of claim 4, wherein the one or more data processors are further configured to provide a test interface, wherein the virtual personality script is provided to a tester without display of the digital avatar, and wherein the tester provides test-test taker responses via the test interface.

6. The system of claim 1, wherein the conversation cycle data record for the particular conversation cycle includes:
a virtual personality script that includes text associated with a first avatar and a question associated with a second avatar, wherein the question inquires about a statement in the text associated with the first avatar.

7. The system of claim 6, wherein the question tests listening and understanding capabilities of the test taker.

8. The system of claim 1, wherein the conversation cycle data record for the particular conversation cycle includes:
a model test taker response associated with a correct answer associated with a cycle link to a correct response conversation cycle data record;
a model test taker response associated with an incorrect response associated with a cycle link to an incorrect response conversation cycle data record.

9. The system of claim 8, wherein the conversation cycle data record for the particular conversation cycle further includes:
a model test taker response associated with an indeterminate response associated with a cycle link to the conversation cycle data record for the particular conversation cycle.

10. The system of claim 9, wherein upon traversing the cycle link associated with the indeterminate response more than a threshold number of times, the cycle link associated with the incorrect response is accessed, wherein the threshold number of times is greater than one.

11. The system of claim 8, wherein a path score record associated with cycle links to only correct response conversation cycle data records identifies a highest conversational aptitude score.

12. The system of claim 1, wherein a first path score record identifies a full credit conversational aptitude score, wherein a second path score record identifies a partial credit conversational aptitude score, and wherein a third path score record identifies a zero credit conversational aptitude score.

13. The system of claim 1, wherein the test taker response is a vocal response that is processed for automatic speech recognition prior to comparison with the model test taker responses.

14. The system of claim 1, wherein the one or more data processors are configured to provide a display that includes a directed graph that indicates relationships among conversation cycle data records as indicated by cycle links.

15. The system of claim 1, wherein a particular path score record includes a conversational aptitude score for each of a plurality of metrics.

16. A computer-implemented method of providing an assessment of a conversational aptitude of a test taker, comprising:
accessing a conversational aptitude data structure that contains:
conversation cycle data records describing a plurality of conversation cycles between a virtual personality and the test taker, wherein a conversation cycle data record for a particular conversation cycle comprises:
a virtual personality script; and
a plurality of model test taker responses and associated cycle links, wherein each cycle link identifies a next conversation cycle data record; and
path score records, wherein a path score record identifies a conversational aptitude score associated with a path of conversation cycle data records;
accessing a first conversation cycle data record;
providing the virtual personality script associated with the first conversation cycle data record;
determining the model test taker response with which a test taker response is most similar;
selecting a next conversation cycle data record identified with the cycle link associated with the most similar model test taker response; and
determining a path score based on a path score record and a path of conversation cycle data records associated with the test taker.

17. The method of claim 16, wherein the virtual personality script is provided for plaintext display or for audio playback in association with video or picture display of a digital avatar of substantially human appearance.

18. The method of claim 16, wherein the conversation cycle data record for the particular conversation cycle includes:
a model test taker response associated with a correct answer associated with a cycle link to a correct response conversation cycle data record;
a model test taker response associated with an incorrect response associated with a cycle link to an incorrect response conversation cycle data record; and
a model test taker response associated with an indeterminate response associated with a cycle link to the conversation cycle data record for the particular conversation cycle.

19. The method of claim 16, wherein a first path score record identifies a full credit conversational aptitude score, wherein a second path score record identifies a partial credit conversational aptitude score, and wherein a third path score record identifies a zero credit conversational aptitude score.

20. A computer-readable medium encoded with instructions for commanding one or more data processors to perform a method of providing an assessment of a conversational aptitude of a test taker, the method comprising:
accessing a conversational aptitude data structure that contains:
conversation cycle data records describing a plurality of conversation cycles between a virtual personality and the test taker, wherein a conversation cycle data record for a particular conversation cycle comprises:
a virtual personality script; and
a plurality of model test taker responses and associated cycle links, wherein each cycle link identifies a next conversation cycle data record; and
path score records, wherein a path score record identifies a conversational aptitude score associated with a path of conversation cycle data records;
accessing a first conversation cycle data record;
providing the virtual personality script associated with the first conversation cycle data record;
determining the model test taker response with which a test taker response is most similar;
selecting a next conversation cycle data record identified with the cycle link associated with the most similar model test taker response; and
determining a path score based on a path score record and a path of conversation cycle data records associated with the test taker.
